(19) United States
(12) Patent Application Publication
(10) Pub. No.: US 2020/0196045 A1
(43) Pub. Date: Jun. 18, 2020

(54) HEADPHONES WITH ELECTROMAGNETIC FIELD SHIELD AND POSTURE CONTROL

(71) Applicants: Giora TAMIR, New City, NY (US); Doron SHAFRIR, Suffern, NY (US)

(72) Inventors: Giora TAMIR, New City, NY (US); Doron SHAFRIR, Suffern, NY (US)

(21) Appl. No.: 16/711,780

(22) Filed: Dec. 12, 2019

Related U.S. Application Data
(60) Provisional application No. 62/780,440, filed on Dec. 17, 2018.

(51) Int. Cl. H04R 1/10; G06F 3/16; G08B 21/04; G08B 5/22

(52) U.S. Cl. CPC H04R 1/1041; H04R 1/105; H04R 1/1025; H04R 2420/07; G06F 3/165; G08B 21/0446; G08B 5/22; H04R 1/1008

(57) ABSTRACT

A pair of headphones has a pair of ear devices positioned in contact with a user's ears, a band located between the ear devices, a transceiver in the band at a distance away from the user's head for low power communication with an electronic device, a pair of speakers in the band and in communication with the transceiver for generating sound, and a pair of sound air chambers extending between the speakers and the ear devices for conveying the sound to the user's ears. An accelerometer in the band detects a tilt angle of the user's head, and generates a posture correction signal when the detected tilt angle is greater than a reference tilt angle.

### FIELD OF THE DISCLOSURE

The present disclosure relates generally to a pair of headphones and like devices worn on user's heads, such as neckbands.

### BACKGROUND

A smartphone held against a user's ear/head in use exposes the user's inner ear and brain to radio frequency (RF) energy and radiates an electromagnetic field (EMF). Such cell phone radiation not only can cause harmful headaches, but also has been classified by the World Health Organization (WHO) as a “possible human carcinogen” due to an increased risk of brain cancer from long-term, cumulative, and heavy use of smartphones, especially by children.

If a pair of traditional wired headphones worn on the user's head is connected by an electrically conductive wire to a smartphone, or a like electronic device, such as a tablet, smartwatch, or computer, that is positioned away from the user's head, then the wire acts like an antenna, and picks up and carries the RF energy emitted by the smartphone/device, and also radiates an EMF even when not in use. This EMF passes into the user's ear/brain. The wire can be eliminated by using a pair of wireless Bluetooth headphones. However, the pair of wireless Bluetooth headphones constantly emits RF energy and radiates an EMF, even when not in use, because the wireless Bluetooth headphones must maintain a connection with the smartphone/device. Thus, the user is constantly exposed to harmful radiation and headaches when wearing wired or wireless headphones, and the deleterious effect of such radiation, even if initially at a low level, is cumulative and increases to a higher level over time.

In addition, many users, when using a smartphone/device, suffer from poor posture, because they typically tilt their heads down to look at their smartphone/device screens, and their shoulders slump forward. Aside from detracting from the users' appearance, poor posture increases physical stress, and can eventually lead to strains, sprains, and more serious injuries.

Accordingly, it would be desirable to provide an improved pair of headphones that does not expose the user to harmful radiation and headaches, and that prompts the user to correct his/her posture when viewing a smartphone/device screen.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a pair of wireless headphones having a band extending across a top of a user's head in accordance with one embodiment of this disclosure.

FIG. 2 is a broken-away, enlarged, top plan of the band of FIG. 1.

FIG. 3 is a diagrammatic view of components within the band of FIG. 2.

FIG. 4 is a perspective view of a wireless neckband having a band extending around a back of a user's neck in accordance with another embodiment of this disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The structural components of the headphones/neckband have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

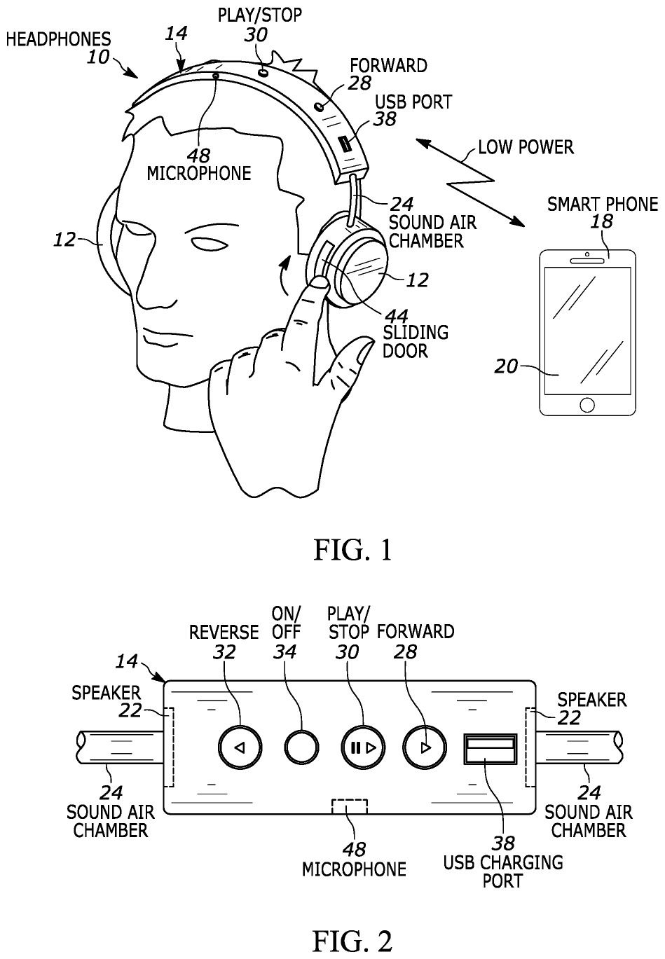

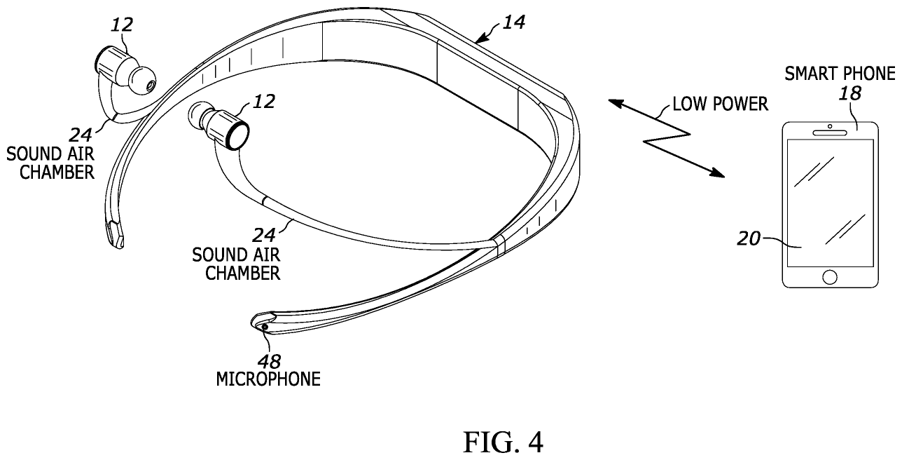

FIG. 1 depicts a pair of wireless headphones 10 having a pair of ear devices 12 positioned in contact with a user's ears. The ear devices 12 may be configured as ear cups or muffs (see FIG. 1) that cover the user's ears, or as earbuds (see FIG. 4) that are inserted into the user's ears. A band 14 is located between the ear devices 12, and is preferably curved. The curved band 14 may extend across a top of the user's head and downwardly towards the user's ears (see FIG. 1), or may extend around a back of the user's neck and forwardly (see FIG. 4). The band 14 is identical in FIGS. 1 and 4, and preferably has the same components described below.

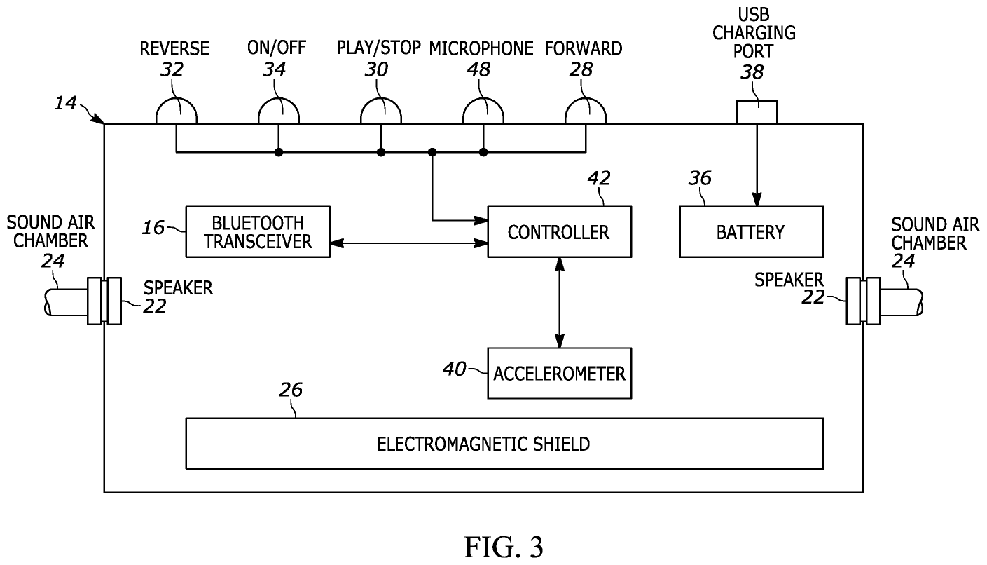

As shown in FIG. 3, one of the components located in the band 14 is a wireless transceiver 16 for low power wireless communication with an electronic device, such as a smartphone 18 having a display screen 20. Although a smartphone has been illustrated in the drawings, it will be understood that other electronic devices may be in communication with the transceiver 16. Such other devices may include tablets, smart watches, smart glasses, cellphones, desktop computers, laptop computers, televisions, radios, digital media devices, and like computer-based devices. The transceiver 16 is located, and spaced, away from the user's head. The transceiver 16 emits RF signals in the microwatt range, for example, on the order of 500 microwatts, and operates preferably by the open Bluetooth Low Energy (BLE) standard, Class 4.

A pair of speakers 22 (see FIG. 3) is also located in the band 14 and is in communication with the transceiver 16 for generating sound. A pair of sound air chambers 24 extends between the speakers 22 and the ear devices 12 for conveying the generated sound to the user's ears. The sound air chambers 24 are hollow, air-filled, flexible, elongated tubes, and are not wires, and hence, do not act as antennas that can pick up RF energy and emit an EMF. In FIG. 4, the sound air chambers 24 may be retractable, for example, by a spring-loaded return mechanism mounted inside or on the band 14, or may be secured out of the way behind the user's neck by magnets provided on the earbuds and/or on the band 14.

An electromagnetic shield 26 is located in the band 14 between the transceiver 16 and the user's head. EMF strength generally decreases and falls off as a function of the inverse of the distance cubed. By locating the transceiver 16 in the band 14 at a short distance away from the user's head, for example, an inch or less, the EMF strength is greatly dissipated. The shield 26 provides additional protection against any radiation emitted by the transceiver 16 towards the user's ear/brain.

Manual controls are also externally located on the band 14 for controlling listening to the sound. Such controls may include, but are not limited to, a forward button 28, a play/stop button 30, a reverse button 32, and an on/off button 34. Such controls are manually accessible to the user, and different controls may be employed. A rechargeable battery 36 is also located in the band 14, and a recharging port 38 is located on the band 14 to charge the battery. The port 38 may be a USB port. Alternatively, the battery 36 could also be charged wirelessly using the open interface Qi standard that defines wireless power transfer using inductive charging.

An accelerometer 40 is located in the band 14 for detecting a tilt angle of the user's head, and for generating a posture correction signal when the detected tilt angle is greater than a reference tilt angle. Preferably, the reference tilt angle is established in advance during an initial setup or training mode. The reference tilt angle may be about zero degrees, which signifies a horizontal level that is generally parallel to the ground. A controller 42 in the band 14 is in communication with the accelerometer 40, and is operative for controlling the training mode to prompt the user to assume a correct head position for a desired period of time, e.g., two seconds or so, when the headphones are turned on for the first time. The controller 42 is also operative for alerting the user that his/her posture or head position is incorrect, or not ideal, or at least different from the head position assumed during the training mode. For example, the controller 42 may darken the screen 20, or successively flash the screen 20 on and off, when the posture correction signal is generated. This action alerts the user to correct his/her posture. Other user alerts may include, but are not limited to, generating a warning sound in the headphones, e.g., a beep sound in the ears, or illuminating a visual indicator, e.g., energizing a light emitting diode (LED).

As shown in FIG. 1, at least one, or both, of the ear devices 12 has a sliding door 44 that is manually movable between a closed position in which external sounds are prevented from reaching the user's ears, and an open position in which the external sounds are permitted to reach the user's ears. This feature is useful when the user is interrupted from listening to the sounds emanating from his/her smartphone or like electronic device in order to hear some external sound, such as another person talking to the user.

Although FIGS. 1-4 depict a wireless headphone/neckband, it will be understood that the headphone/neckband could also be wired. A microphone 48 may be added to the headphone/neckband. The microphone 48 may be incorporated into the band 14, or may be located remotely from the band 14 and be connected to the headphone/neckband via a wire, preferably routed through one of the sound air chambers 24.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, or contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A pair of headphones, comprising:
a pair of ear devices positioned in contact with a user's ears;
a band located between the ear devices;
a transceiver in the band for low power communication with an electronic device, the transceiver being located away from the user's head;
a pair of speakers in the band and in communication with the transceiver for generating sound; and
a pair of sound air chambers extending between the speakers and the ear devices for conveying the sound to the user's ears.

2. The headphones of claim 1, wherein the ear devices are selected from a group consisting of ear cups that cover the user's ears, and earbuds that are inserted into the user's ears.

3. The headphones of claim 1, wherein the band extends across a top of the user's head.

4. The headphones of claim 1, wherein the band extends around a back of the user's neck.

5. The headphones of claim 1, wherein the transceiver is wireless and emits low power, radio frequency energy in the microwatt range.

6. The headphones of claim 1, wherein the sound air chambers are hollow, air-filled, flexible, elongated tubes.

7. The headphones of claim 1, and an electromagnetic field shield in the band between the transceiver and the user's head.

8. The headphones of claim 1, and manual controls on the band for controlling listening to the sound.

9. The headphones of claim 1, and a rechargeable battery in the band, and a recharging port on the band to charge the battery.

10. The headphones of claim 1, and an accelerometer in the band for detecting a tilt angle of the user's head, and for generating a posture correction signal when the detected tilt angle is greater than a reference tilt angle.

11. The headphones of claim 10, and a controller in communication with the accelerometer, and operative for alerting the user when the posture correction signal is generated.

12. The headphones of claim 11, wherein the controller is operative for prompting the user to assume a correct head position corresponding to the reference tilt angle during an initial training mode.

13. The headphones of claim 11, wherein the controller is operative for controlling a screen of the electronic device when the posture correction signal is generated.

14. The headphones of claim 1, wherein at least one of the ear devices has a door that is movable between a closed position in which external sounds are prevented from reaching the user's ears, and an open position in which the external sounds are permitted to reach the user's ears.
